(19) United States
(12) Patent Application Publication
(10) Pub. No.: US 2012/0265666 A1
(43) Pub. Date: Oct. 18, 2012

(54) METHOD AND SYSTEM FOR INTEREST RATE SWAPS

(75) Inventors: Sunil Hirani, Greenwich, CT (US); James Miller, New York, NY (US)

(73) Assignee: TRUEEX GROUP LLC, New York, NY (US)

(21) Appl. No.: 13/446,998

(22) Filed: Apr. 13, 2012

Related U.S. Application Data
(60) Provisional application No. 61/517,110, filed on Apr. 13, 2011.
(60) Provisional application No. 61/627,868, filed on Oct. 18, 2011.
(60) Provisional application No. 61/686,113, filed on Mar. 29, 2012.

(51) Int. Cl. G06Q 40/04

(52) U.S. Cl. 705/37

(57) ABSTRACT

The present invention is a system and method for providing improved functionality to an interest rate swap platform. The improved system includes functionality implementing single interest rate sale sessions initiated either as a result of market conditions or a user request, risk adjustment sales to allow users to balance portfolio risks, consolidated sweeps to more efficiently allow a user to manage an investment swap portfolio, and credit limit clearance functionality to improve the management of credit limits associated with users and clearance facilities.

### PRIORITY INFORMATION

The present application is a utility application, and claims priority to the U.S. Provisional Application Ser. No. 61/517,110, filed on Apr. 13, 2011, titled Method and System for Interest Rate Swaps, Ser. No. 61/627, 868, filed on Oct. 18, 2011, and titled Method and System for Interest Rate Swaps, and Ser. No. 61/686,113, filed on Mar. 29, 2012, titled Credit Limit Concept in the names of Sunil Hirani and James Miller, the contents of each of which are incorporated herein in their entireties by reference thereto.

### BACKGROUND

The present invention relates to the provision and distribution of information related to interest rate swaps to implement an efficient market for the offering and acquisition of interest rate swaps.

Interest rate swaps, such as simple swaps in which an offeror offers to swap the interest associated with a fixed rate for a notional amount for the interest associated with a variable rate on the same notional amount, or more complex transactions such as a swap involving a switch trade, which involves multiple swaps over different periods of time (referred to as the tenor of the swap) such as a 2×10 switch in which the offeror and an acquirer first implement a simple two year swap, followed by a 10 year swap with the roles reversed (i.e., the offeror first pays interest at a fixed rate, then changes roles and pays interest at a variable rate), allow financial entities to hedge risk associated with interest rates as they vary over time.

The trading of interest rate swaps is dependent on connecting offerors and acquirers who have comparable needs, i.e., are offering and willing to take in swap comparable rates, over comparable tenors, and for comparable notional amounts. Furthermore, the involvement of large entities, which can be referred to as market makers, can affect the market when the identity of the market maker is known, making it a benefit for the identity of the offeror or acquirer to be unknown. The ability of parties to complete trade swaps, i.e., financially complete the interest rate swap, implicates the presence of credit limits associated with the offerors and/or acquirers, such that third parties providing financial support to the parties to the rate swap can also become involved in the transaction. Finally, the ability of acquirers to efficiently monitor the state of the market for interest rate swaps becomes critical, as once a market price has been established, liquidity can be attracted to that market price.

### SUMMARY OF THE INVENTION

The present application is a system and method for providing an interest rate swap platform enabling improved specific interest rate market sessions, risk adjustment sales sessions, and consolidated sweeps, in an environment in which credit limit intervention is integrated.

In a simple form, the system of the present invention is a computer implemented interest rate swaps platform having a computer system including a plurality of user interfaces. The computer system is provided with a market evaluator for determining market conditions associated with interest rate swaps; a specific interest rate market module which implements single interest rate market sessions, risk adjustment sales module which implements risk adjustment sales, a consolidates sweep module which allows users to perform consolidated sweeps of existing portfolios, a client credit restriction module which implements credit limit restrictions from third party credit facilities, and post transaction module.

The present invention is also embodied in a process in which an interest rate swap platform is established; users are communicably connected to the platform; the platform monitors interest rate swap market conditions; the platform provides users with information regarding the market conditions; the platform analyzes market conditions to determine whether a specific interest rate market session should be initiated; monitoring user interferences to identify when a user requests a specific interest rate market session; when it is determined that specific interest rate market session should be initiated, initiating said specific interest rate market sessions; periodically initiating risk adjustment sales sessions; monitoring the user interfaces to identify when a consolidates sweep is requested; initiating a consolidated sweep when one is requested by a user; and imposing on any proposed transactions a credit limit provided by a third party credit facility.

### BRIEF DESCRIPTION OF THE FIGURES

FIG. 1 illustrates a system for implementing an interest rate swap platform according to the present invention.

FIG. 2 illustrates a notional user interface for a user to interact with the interest rate swap platform for interacting with a specific interest rate product sale.

FIG. 3 illustrates a notional market depth display that may be provided to a user.

FIG. 4 illustrates a notional display for providing information to a user regarding the available size for Volume Weighted Average Price across multiple orders in a book.

FIG. 5 illustrates a matrix display for live and tradable Switch prices showing the short-leg on the left axis and the long-leg on the bottom.

FIG. 6 illustrates a process for invoking and conducting a specific interest rate product sale session on the overall interest rate swap platform.

FIG. 7 illustrates a notional display for informing users that a specific interest rate product sale session has been initiated.

FIG. 8 illustrates a notional user interface to allow a seller of a trade-initiated a specific interest rate product sale to enter its specific interest rate product sale order.

FIG. 8A illustrates a notional user interface to present information to a user during a specific interest rate product sale to allow the user to receive information in real time.

FIG. 9 illustrates a notional user interface for a participant to allow the participant to select orders to re-activate from a previous risk adjustment session by checking the orders to include.

FIG. 10 illustrates a notional display of a participant's submitted position relative to all other submitted positions in a risk adjustment session run.

FIG. 11 illustrates a notional display to inform a user of matches and near-matches resultant from a first pass of a risk adjustment session run.

FIG. 12 illustrates a notional display for a user to interface with the platform to adjust date tolerances to increase the chances of matches.

FIG. 13 illustrates a notional risk adjustment session user interface for displaying potential non-standard tenor switches.

FIG. 14 illustrates a notional user interface for predictive and actual matching of non-standard tenor switches in an overall interest rate swap platform, as driven and updated by adjustment to user tolerances to show coverage of the user's order across multiple date ranges.

FIG. 15 illustrates a notional user interface for confirmation for a Consolidated Sweep order.

FIG. 16 illustrates a notional user interface to allow the user to define their preferred executing participants as part of their clearing routes.

FIG. 17 illustrates a notional user interface for allocating limits associated with a credit limit function.

FIG. 18 illustrates a notional user interface for allocating limits associated with a credit limit function.

FIG. 19 illustrates a notional user interface for managing credit line warnings as a percentage of existing credit limits.

FIG. 20 illustrates a process for posting a CLOB order.

FIG. 21 illustrates a notional user interface to allow users to request additional credit.

FIG. 22 illustrates a notional user interface for informing a user when a credit limit has been exceeded.

FIG. 23 illustrates a notional user interface for allowing a clearing firm to analyze the status of credit limits for any entity that they have permission to clear trades.

FIG. 24 illustrates a basic process for operating an interest rate swap platform in accordance with the present invention.

### DETAILED DESCRIPTION OF THE INVENTION

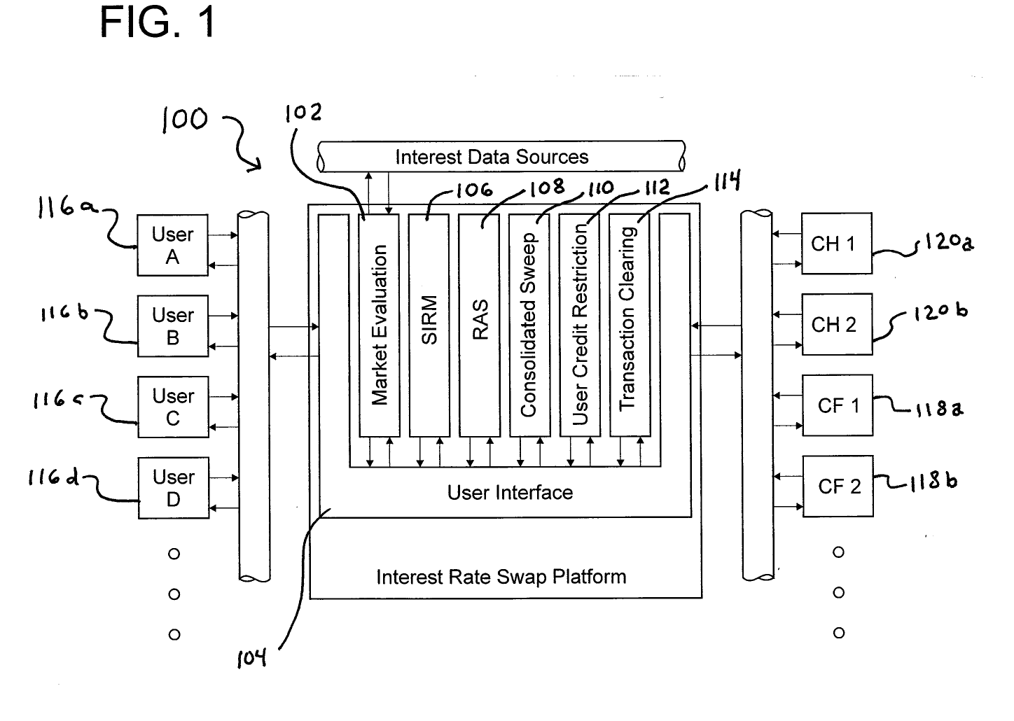

As shown in the Figures, in which like numerals are used to identify like elements, there is shown an embodiment of the present invention. In FIG. 1, there is shown a system 100 for implementing interest rate swaps.

The interest rate swap platform may utilize six functional modules, to address different aspects of the process associated with providing the interest rate swap platform. While these are described in terms of modules, nothing requires modular construction of the system and method in accordance with the present invention, modules are simply used for the added clarity they allow to the below discussion. These modules are market evaluation 102, client interface 104, specific interest rate product sales 106, risk adjustment sales 108, consolidated swap processing 110, client credit restriction tracking 112, and transaction clearing 114. These functional modules are implemented on an internet or other network accessible server, such that information associated with implementing interest rate swaps can be efficiently disseminated from the server to interested parties, including offerors, acquirers, (collectively referred to as users 116a, 116b, 116c, 116d) third party entities involved in credit restrictions, such as credit facilities (118a, 118b . . . ). Finally, the system may further include functionality to allow clearing of transactions, such as reporting of completed swaps to clearinghouses 1203, 1206.

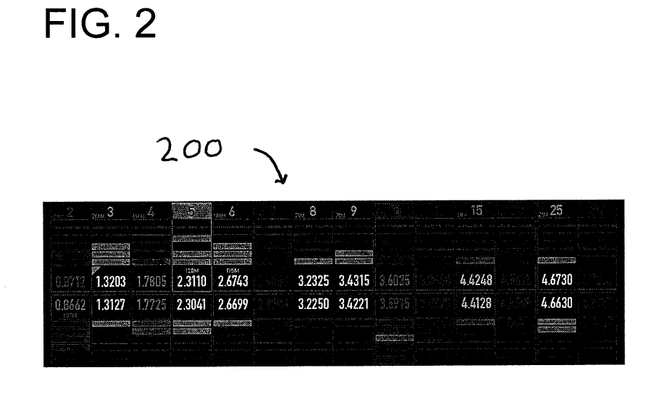

The client interface is utilized to provide efficiently displayed and organized information regarding open offers for credit rate swaps. As shown in FIG. 2, the display interface 200 may include the following features: market prices for the best bid and offer may be displayed in a left-to-right manner, mimicking a typical interest rate curve; order depth may be displayed in real-time across multiple tenors for both interest rates and spreads products so that market activity is immediately obvious; and bids may be displayed below the offer (because the bid level is always below the offer, except when trading) to accurately reflect an order stack.

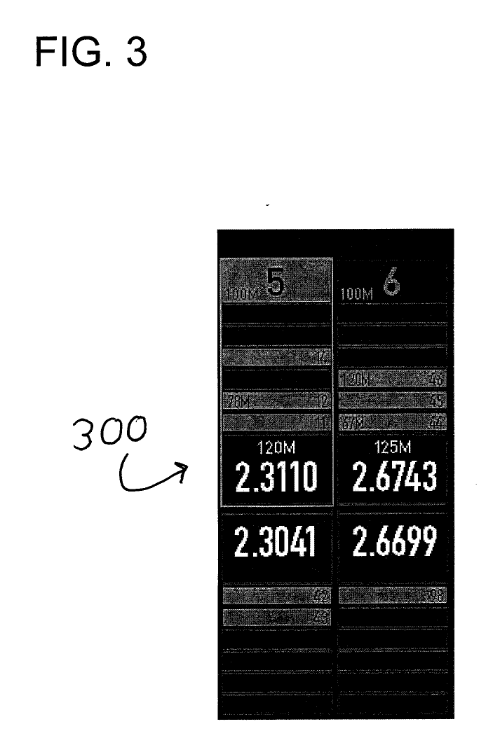

Market depth may be readily displayed with respect to each tenor by having each point shown as a specific price increment from the best and indicating where orders are of no standard size (with their size indicated on the price point) for ease of access to the details in the stack while still being able to see activity across the entire market, as shown in FIG. 3. In FIG. 3, it can be seen that there is a total of 398M in offers in the 5 year tenor (278M in depth) at price points 2.3110 (120M), 2.3111 (100M), 2.3112 (78M) and 2.3114 (100M). There is also 412M in depth in offers in the 6 year tenor (287M in depth) at price points 2.6743 (125M), 2.6744 (67M), 2.6745 (100M), and 2.6746 (120M). The disclosed display 300 provides a comprehensive view of market depth which may be used to further inform a user as to the state of the market and a tenor in particular.

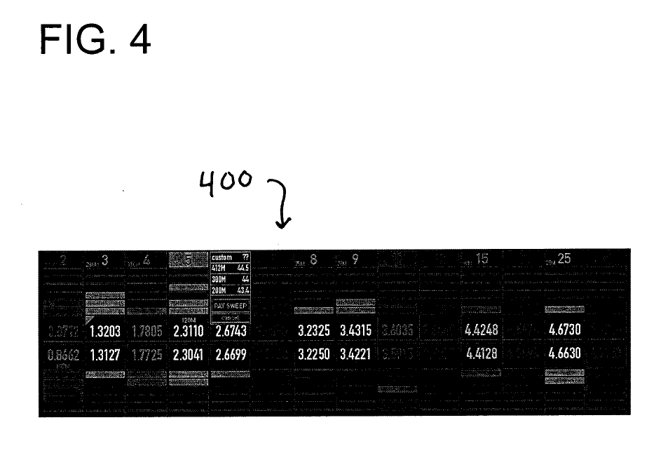

As shown in FIG. 4, a visual display 400 of the available size for volume weighted average price (VWAP) across multiple orders in a book is displayed with the ability for a user to specify a notional amount to immediately determine the VWAP price for that amount.

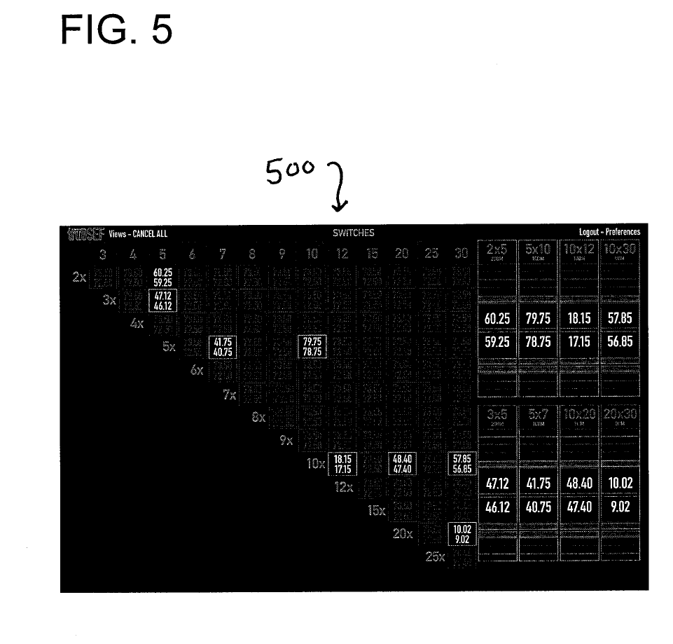

As shown in FIG. 5, a matrix display 500 for live and tradable Switch prices showing the short-leg on the left axis and the long-leg on the bottom may be provided. The prices update in real-time and can be traded with two clicks.

The specific interest rate product sales module (SIRM) 106 may implement a process for enabling specific interest rate swaps. The module may create a session in which offerors are matched with acquirers based on information provided by the offerors and/or acquirers. The SIRM sessions may be created for a specific interest rate product (e.g., outrights, spreads, switches, flies) and a specific tenor only (e.g., 2 year, 5 year, 2×10, 5×7×10). They may have no impact on other products or other tenors for this product. Each SIRM session may have its own order book.

The SIRM process works as a fully integrated aspect of the overall interest rate swap platform (an enterprise platform). The overall interest rate swap platform may be a central limit order book (CLOB) platform for trading liquid tenors in the interest rate swaps market. In one embodiment, the SIRM process may depend on the existence of the overall interest rate swap platform for providing live pricing and order matching which govern the creation and execution of SIRM sessions. It also may provide post-trade processing capabilities to ensure SIRM trades are settled and cleared after they are matched in a session.

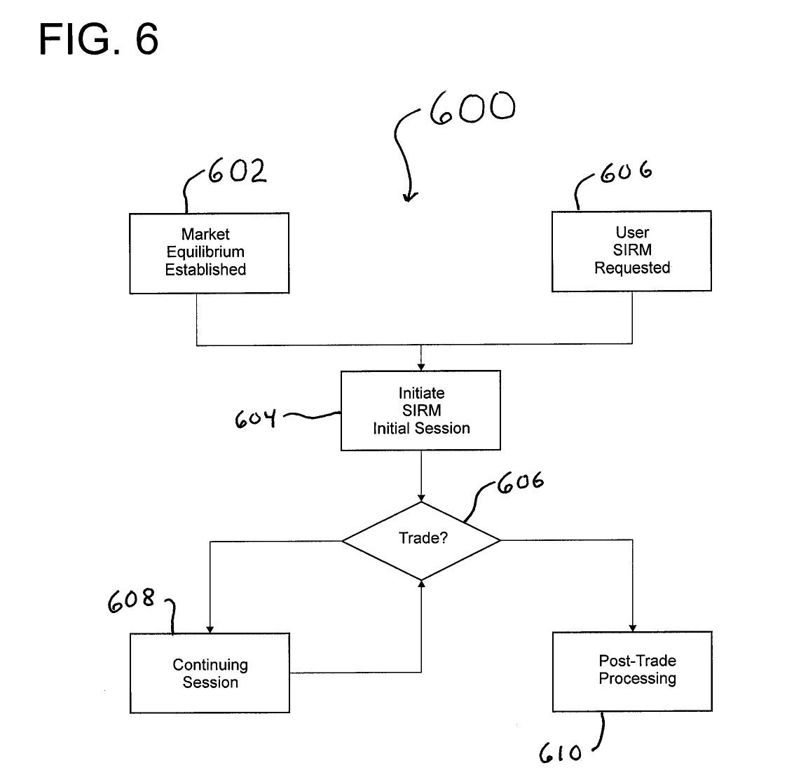

FIG. 6 shows the process 600 for invoking and conducting a SIRM session on the overall interest rate swap platform. Specific steps may include the following:

Establishing a Market Equilibrium Level.

The first step may be establishing 602 a market equilibrium level, either via a trade on the overall interest rate swap platform or via a user-initiated session. The institution of a reported trade outside of a session can establish a market point for swaps, such that a session can be initiated 604 based on the parameters of the reported trade. Alternately, a session can be initiated as the result of parameters being offered by a system user.

If a user initiates an SIRM session 606, the following rules may apply:

The market equilibrium level should be within the current, live bid-offer spread on the interest rate swap platform for the product being traded (including implied bid-offer spread for switches and butterflies). The market equilibrium level should be higher than the best bid and lower than the best offer. If no bid or offer exists, the overall interest rate swap platform may use an interpolated curve to estimate the bid-offer for the purpose of keeping the market equilibrium level between the spread.

The user may be required to indicate if he is a buyer or seller (or both).

The user may be required to indicate the intended notional for its order. The following rules may apply to notional on a user-initiated SIRM session: the notional must be above a specific minimum—which are tenor-dependent that are specific to SIRM sessions and the tenor of the product; and the minimum size of the notional must always be greater than the minimum size for the overall investment swap platform (for normal trading).

If a SIRM session is initiated as a result of a trade, the following rules may apply: The participants to the trade always have the top priority for orders they enter into the SIRM order book and their orders are processed as follows: any unfilled portion of the orders in the trade will automatically be moved to a SIRM order book; and participants can add to their orders at any time during the SIRM session—and they will retain top priority. Existing normal platform orders at the traded level are entered into the SIRM order book by default (in their current priority as the interest rate swap platform order book). The user may cancel the order at any point during the SIRM session as long as the order is not matched.

Conducting an Initial SIRM Session.

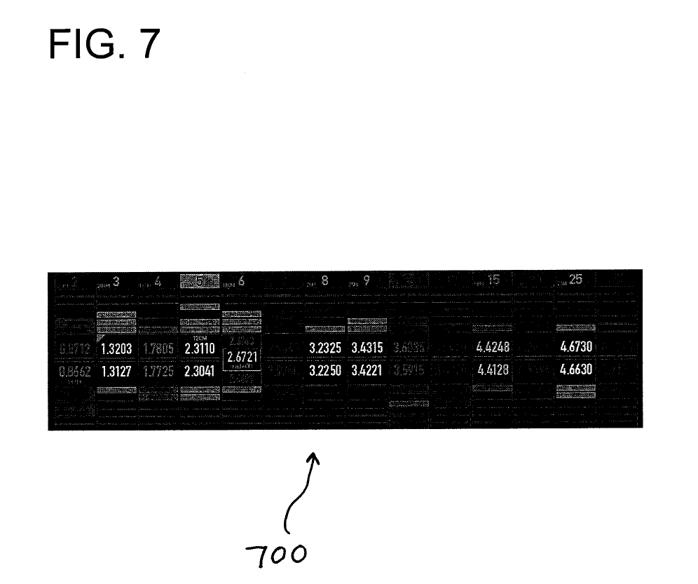

Simultaneously, a SIRM window may be displayed to market participants to inform them that a SIRM session has been initiated such as the display 700 shown in FIG. 7. Participants may submit their orders immediately (and, in one embodiment, will be queued in priority order, as discussed further below) prior to the SIRM session matching orders. The disclosed interfaces provide substantive functionality that provides to a user a market-level view which may be used to inform critical trade decisions which may be made in real-time.

SIRM order matching can occur in two distinct phases: an a) initial session and b) continuing session. The initial session may be a limited time window (assumed to be 10 seconds, but configurable and adjustable as market conditions demand) during which no trades occur until the end of the session. (Note: the exception is if the two original participants trade in a trade-initiated SIRM session as discussed below.

Once an initial SIRM session begins, traders from any participant on the overall interest rate swap platform may submit an order to buy or sell specified sizes at the indicated market equilibrium level. Orders placed into this order book are not visible to the market at any time. Orders are assumed to be limit orders at a market equilibrium level and should include the following information: order notional, which must be in valid increments of the lot size and can vary by tenor and product; and order direction, either buy or sell, but cannot be both. The initial traders in a trade-initiated SIRM may be precluded from changing their direction (i.e., the seller must remain on the sell side), as should the initiator of a user-initiated SIRM session.

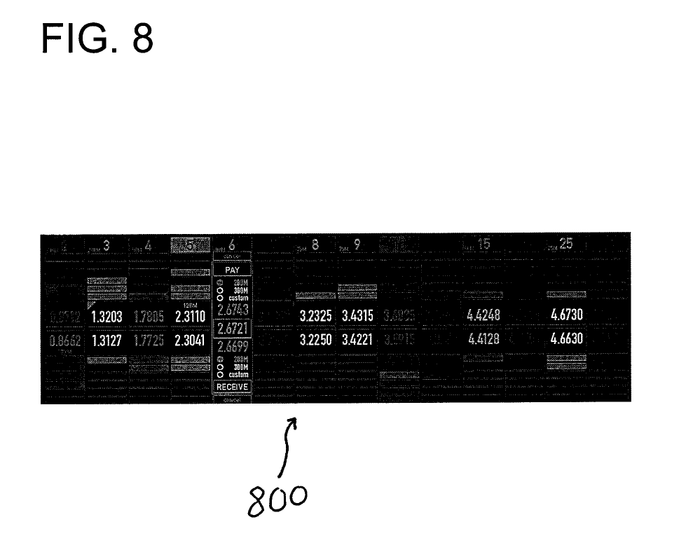

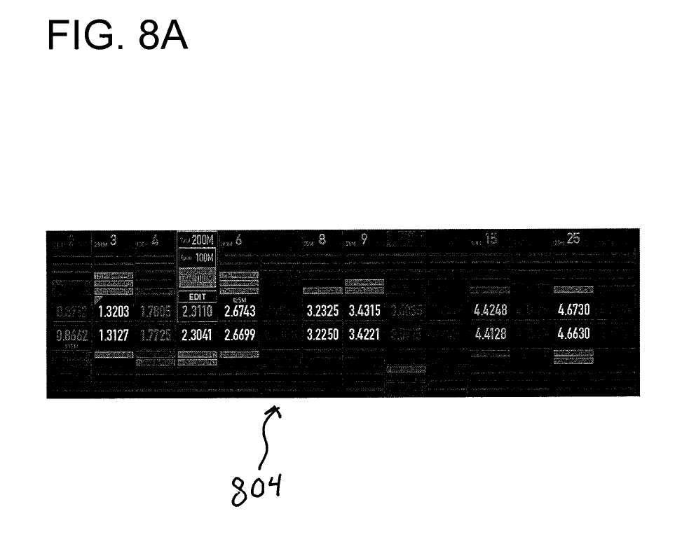

FIG. 8 shows how the seller of a trade-initiated SIRM would enter his SIRM order (if desired) through an order interface 800. Orders are queued in priority during the initial window. Participants may cancel or update their orders during the initial session at any time prior to the end of the session without impact.

In one embodiment, participants may have only one active order per SIRM session, in a single direction. If the participant enters a new order in either direction, it may be assumed to replace the existing order.

As the SIRM session progresses, participants may be updated as to the status of their orders. Order status may be provided in real-time, and, in a further embodiment, with real-time market data that may be used to indicate an assessment 804 of the order. This is shown in FIG. 8A.

Order Priority During The Initial SIRM Session.

Orders entered during the initial SIRM may be prioritized as follows: The participants in a trade (if trade initiated) or the initiator (if user initiated) are the top priority in the SIRM order book; the participants priority may be limited based on the side they were on in the trade, i.e., their priority applies to the side they are on; participants in the SIRM platform order book have the same priority in the initial SIRM session as they do in the order book (save for the top priorities); and for participants not in the order book, orders are prioritized by the time of submission. If a participant has the best bid, the participant is next priority on the buy side (after participants in the trade or buy-side initiator, if any). This may apply to either trade-initiated or user-initiated SIRM sessions. With respect to priority of submission, earlier submission may be a higher priority, notional increases may be treated as an amended order and retain the time priority of the original order, and notional decreases may be treated as a new order with their time priority being the time of the decrease.

Order Execution During The Initial SIRM Session.

Orders in the initial SIRM session may be matched at the end of the session and based on the priority order. To complete the matching, the following may happen: buy and sell order notional amounts may be totaled and compared; if either side is zero, no orders are executed; if the totals are equal, all orders may be executed; if either is larger, all the orders for the side with the smaller total may be executed, and on the side with the larger total, orders may be sequentially executed as follows: the available order size is set to the total of the smaller size, and the top priority order notional is compared to the available order size. If the top priority order notional is smaller, the order may be fully executed with the size of the order subtracted from the available total to get a new available total. If the top priority order notional is the same size, the order may be fully executed, with the matching process ending. If the top priority order notional is larger, the amount executed may be the available size with the remaining amount created as a new order (with top priority) in a SIRM continuing session. The process may repeat until the available size is exhausted. At that point, all remaining orders on the larger notional side may be moved to a SIRM continuing session with the same priority.

Even though orders may be marked as executed, actual trades may not generated until the SIRM session terminates. Participants may be notified that their orders have been matched so they are aware of the total notional they have traded in the SIRM session at all times. Trade minimization for SIRM sessions is discussed further below.

Conducting Continuing SIRM Sessions.

Following the initial SIRM session, if 606 there are any trades that are created the platform may initiate 608 a continuing SIRM session (assumed to be for 15 seconds, but configurable and adjustable as market conditions demand). Whenever there is a trade during the continuing session, the continuing SIRM session timing can restart. This may be allowed to continue until the defined amount of time elapses without a trade or the session terminates due to orders in the normal order book (see below on SIRM terminations). Therefore, a SIRM session may continue as long as trades continue to be matched. This allows for the maximum volume to be cleared at the Market Equilibrium level.

Alternately, the continuing session may be implemented for a fixed time, with a new continuing session initiated at the end of the previous session if both a trade occurred in the previous session, and orders for the particular interest rate swap remain.

Unmatched orders from the initial SIRM session may be moved to a continuing session—but alternately may be cancelled at any time (as during the initial session). New orders may be submitted at any time and contain the same information as described above for the initial session.

During the continuing session, if no contra order exists, new orders may be prioritized only by time order.

If there are active contra orders when a new order is placed, the platform may process the new order as follows: the notional of the new order may be compared to the top order on the contra side. If the new order is smaller, the new order may be fully executed and the contra order may be executed for the notional of the new order. The remaining size may be created as a new order—with top priority. If the new order is the same size, the new order and the contra order may be fully executed and the matching process may end. If the new order is larger, the contra order may be fully executed and the new order may be executed for the size of the contra order and the remaining notional of the new order may be created as a new order. The process may repeat until there are no contra orders left in the order book.

Even though orders are marked as executed, actual trades may not be generated until the SIRM terminates. As with the initial session, participants may be notified that their orders have been matched so they are aware of the total notional they have traded in the SIRM session at all times. A trade minimization approach for SIRM sessions is discussed further below.

SIRM Session Post Trade Processing.

The SIRM session post trading processing 610 may encompass three functions: minimizing trades, post trade processing, handling remaining orders and re-initiating SIRM sessions.

Minimizing Trades.

The platform may be configured to minimize the number of trade tickets generated during SIRM sessions. This is done to help reduce operational costs to users. The platform may take all trades generated during the SIRM sessions and ensure that there is only one trade per pair of participants. For example, if participant A buys from participant B three different times (via several different orders in the SIRM) for $100 MM, $150 MM, and $75 MM, instead of generating three tickets, the interest rate swap platform may create a single ticket for $325 MM.

Post Trade Processing.

Following the SIRM session, if any trades are executed, the interest rate swap platform may process the trades in the same manner as regular trades executed via a normal order book. This may include sending trades to market services (e.g., MarkItSERV), clearing houses, and any counterparties involved.

Handling Remaining Orders and Re-Initiating SIRM Sessions.

If a user has an open order when a SIRM session terminates, the user may be given the option to post the remaining order as an iceberg order on the interest rate swap platform or save the order for initiating a future SIRM session. Users may access and repost saved orders as a SRIM order (either to initiate a new session or to join an existing session).

The exception is an order posted as a normal order (to the regular order book). These orders may be moved back to the normal order book at the end of the SIRM session with priority based on initial time that the order was sent to interest rate swap platform and handled as normal, e.g., it could create a trade immediately.

SIRM Special Cases.

Several additional rules may be implemented with respect to SIRM sessions. During the SIRM sessions, the normal order book for a specific product and tenor on the interest rate swap platform may operate as follows:

If an order comes in worse than the clearing level (lower for bid, higher for offer), the order may be placed into the normal order book and follow existing normal platform rules.

If an order comes in at the clearing level in the normal order book, the order may be moved to the SIRM order book for the duration of the SIRM session.

If an order comes in at a price better than the clearing level, the platform may attempt to match the order in the SIRM order book. During the initial session, a better-than-market order may be precluded from being matched until the session timer expires. Therefore, it may be held during that time until the matching occurs. At that time—and during the continuing SIRM session, the following rules may apply: If the order can be matched for the full notional, the order may be traded as normal for a SIRM order (at the clearing level) and processing may continue as normal; if the order can be matched—but only for a partial size of the notional of the new order, the order may be traded for as much notional as possible but since it is a partial fill, the SIRM session (regardless of initial or continuing) may be ended and the order placed into the normal order book at its original level; if the order cannot be matched, it may remain as an order in the SIRM session (regardless of initial or continuing) until the session terminates. At that time, the order may be placed into the normal order book at its original level. This means a second trade could be precluded from occurring during an existing SRIM session (for the same tenor, product).

Simultaneous SIRM Sessions for the Same Product and Same Tenor.

SIRM sessions should be prevented from occurring simultaneously at different price levels for the same product and same tenor. They may occur across different products or across the same product but at different tenors. This implies the following: While an existing SIRM session is active for a particular product and tenor, a new session may not be initiated by a user for that same product at the same tenor (functionality is disabled); and a trade-initiated session for that product at the same tenor may not be created (see previous section on operation of normal order book for why this could never happen).

Termination of an SIRM Session.

SIRM sessions may be terminated in one of the following ways: if the continuing session has no trades for the defined-duration of the continuing session (assumed to be 15 seconds); or if at the end of the initial session or at any time during a continuing session, there are no active orders for the SIRM session. Alternately, the SIRM session may not terminate until no trades occurred within a set time period, or if there was o active orders outstanding.

SIRM Trading Example.

In order to demonstrate how the SRIM process works, the following examples show how the original liquidity level may be defined on the interest rate swap platform and how the resulting SRIM sessions would operate.

10:04:22 AM—Market Maker A submits orders to create a 99/101 market in the One Year Dollar Swap. The “best” market shown on the client is 99/101.

10:04:46 AM—Market Maker B submits a 99.5 bid order in the One Year Dollar Swap. The “best” market shown on the client is 99.5/101.

10:05:36 AM—Market Maker C submits a 98.5 bid and a 100.5 offer in the One Year Dollar Swap. The “best” market shown on the client is 99.5/100.5.

10:06:02 AM—Market Maker B updates the bid order in the One Year Dollar Swap to be 100. The “best” market shown on the client is 100/100.5.

10:06:12 AM—Market Maker C updates the offer order in the One Year Dollar Swap to be 99/100. The “best” market shown on the client is 100/100 so there is a touching (matched) market.

10:06:13 AM—Given that there are touching orders, the interest rate swap platform may determine that a SIRM session should be opened for the One Year Dollar Swap at 100. Clients on the interest rate swap platform may be notified (on their screen or via an API message). The overall interest swap platform may open the SIRM window and the application may enable submission of orders. Expiration of this session window is set to 10:06:23 AM. Participants may be given ten seconds (initially) to submit either buy or sell orders. Market Maker B may be the top priority on the buy side, Market Maker C may be the top priority on the buy side, Market Maker A may be second priority (by virtue of being in the order stack) on both the buy and sell side of the SIRM order book. Market Maker C would be the third priority on the sell side—but would not be because Market Maker C is a seller and so cannot be on the buy side.

10:06:15 AM—A buy order for $100 MM is submitted by Submitter B1 for the product and is placed at the top of the queue.

10:06:20 AM—A second buy order is submitted, this one for $400 MM by Market Maker B. The interest rate swap platform determines that the new order should be placed first in the queue (based on priority rules).

10:06:22 AM—A sell order for $100 MM is submitted by S1.

10:06:23 AM—The initial SIRM session ends. At this time, the Sell order from S1 is immediately filled against buy order from Market Maker B for $100 MM (conditionally, see above on minimizing trade tickets); the remaining amount of Market Maker B ($300 MM) becomes a new order at the top of the Buy queue; and a continuing session for this SIRM is opened with an expiration of 10:06:38 AM. The client continues to show the SIRM session is open.

10:07:35 AM—Another buy order is submitted by submitter B3 for $250 MM. The truSEF platform places the new order in the appropriate place on the queue (based on priority rules)—in this case at the bottom of the queue.

10:07:38 AM—A sell order is submitted for $1000 MM by S2. At this time: the order is immediately filled against as much size in the buy queue as possible (conditionally, see below on minimizing trade tickets). The top order in the buy order queue is fully filled (for $300 MM); as are the second (for $100 MM) and third (for $250 MM) buy orders; the sell order is not fully filled so the remaining amount ($350 MM) becomes a new order at the top of the sell queue; and this continuing session ends and a new continuing session is started. The client continues to show the SIRM session is open.

10:07:53 AM—The continuing ends. Because there was a trade and orders remain, a new continuing session is initiated with an expiration of 10:07:53 AM

10:07:52 AM—With no further trades, this SIRM session closes.

The interest rate swap platform determines the specific trades completed (and tries to minimize the number of trades) and sends trade notifications to the various members. The specific trades are: market Maker B buys $400 MM from Submitter S2; submitter B3 buys $250 MM from Submitter S2; and submitter B1 buys $100 MM from Submitter S1.

Risk Adjustment Sales.

The objective of the Risk Adjustment Sales (RAS) platform is to enable participants to adjust their risk exposure across the interest rate curve in a highly automated and efficient manner that minimizes DV01 impact (ideally has an overall DV01 impact of 0). It is not intended to be used to put on a specific risk position—hence the concept strives to execute switch-based trades that are very nearly DV01 neutral (within a certain user-defined tolerance).

A key component of the RAS platform is it relies on DV01 impact to determine notionals of orders and determine matches. DV01 measures the impact of shifting the interest rate curve by one basis point at the defined maturity and by its nature is duration weighted. Therefore, at present interest rates, i.e., about 1½ percent, to have a DV01 impact of $50,000 requires trading notional of approximately $105 MM on a Five year swap and approximately $58 MM on a 10 year.

A switch trade in the context of this document is a trade that has two legs—a short-dated leg and a long-dated leg. For example, a 2×10 switch involves the counterparties doing essentially two separate trades—a 10-year interest rate swap and a 2-year interest rate swap with the payer and receiver roles switched for each trade. Typically, such trades are DV01 neutral at the time of the trade, therefore, the notional amount on the short-dated leg is duration-weighted to match the DV01 impact of the long-dated leg. By market convention, the switch “buyer” is the party that is receiving floating-rate payments/paying fixed-rate payments on the long-dated leg and vice versa on the short-dated leg.

Interest rate swaps, regardless of underlying currency, trade frequently on a standard set of tenors (primarily 2-10, 12, 15, 20, 25, and 30 year). As time progresses, swap dealers and major swap participants that have traded in these tenors have their curve exposure shift down the interest rate curve. For example, after 3 months a five-year swap becomes and 4.75 year swap. These non-liquid tenors do not trade significantly, so it becomes difficult for an institution to adjust their overall risk exposure. They either have to trade in illiquid tenors or use other hedging mechanisms.

The RAS platform provides an automated and efficient solution to this issue—while keeping positions anonymous.

Types of Matching.

The RAS platform may perform two types of matching to offset reset risk for full term of an interest rate swap. In the initial phase, all orders should be entered as a switch (a duration-weighted trade of a short-dated leg and a long-dated leg with nearly zero overall DV01 impact), which implies a participant-defined linkage between legs. In future phases, orders may be entered individually—where they would be paired by the platform to create (relatively) DV01 neutral switches.

The initial phase may simplify the process as it focuses on user-defined switches to be matched. The future phases may maximize the possible matches since any set of orders could be paired to create a switch

Process.

The RAS process may run on a regular, periodic basis. Specific timing could be market-driven, i.e., based on the needs of participants and backlog/volume of trading. Participants may be informed of the time deadlines for submitting their orders and setting matching parameters.

The RAS process may comprise at least four main steps: Pre-Submission Review; Order submission; trade matching, first run; and trade matching, second run.

Pre-Submission.

Prior to the designated time for executing the RAS process, participants may review their position book and unmatched RAS positions to determine what orders to activate in the next process. Participants may access their unmatched orders from previous RAS sessions and reactivate them as desired. Participants may also review the results of previous RAS runs to identify areas of activity and possible matches.

Order Submission.

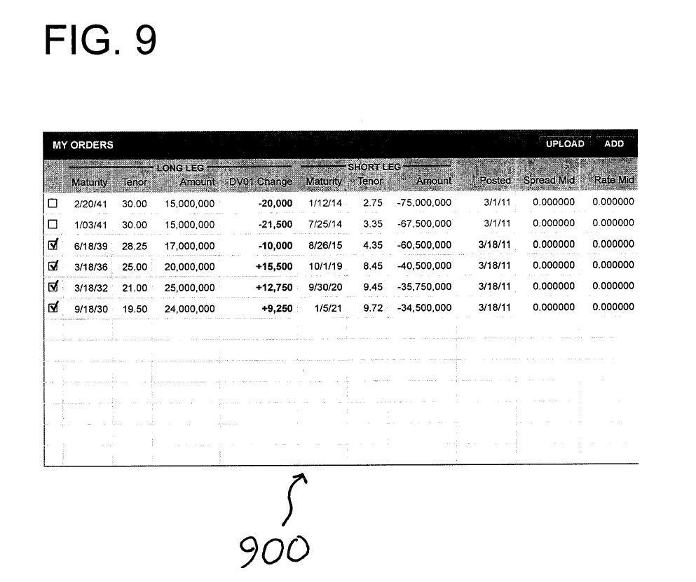

Before the designated time for executing the RAS process, participants may submit their positions (as orders) anonymously for all tenors on which they care to adjust their risk. Participants can reactivate unmatched orders from previous RAS sessions. FIG. 9 shows a display 900 illustrating an example of a participant selecting to re-activate orders from a previous RAS by checking the orders to include.

The RAS platform may support switches or single legs as orders. Orders may be entered as: duration-weighted switches; or individual switches. For duration-weighted switches, participants may enter the following details of the switch: whether the switch will be active in the next RAS process; a short-dated leg tenor; a long-dated leg tenor; whether they are paying or receiving fixed on the long-dated leg; and a long-dated leg notional or DV01 impact limit. The RAS platform may then calculate: on the long-dated leg, DV01 impact if notional is entered or notional if DV01 impact is entered; on the short-dated leg, if they are paying or receiving fixed (opposite of long-dated leg) and both the DV01 impact and the notional—as overall DV01 impact of the switch is assumed to be zero, the date the order was posted; and the expected rate and/or spread of the switch (based on market prices at the time). For individual legs, each leg of the order should have a tenor, payer/receiver, notional or DV01 change. The direction of the leg (payer/receiver) may be reflected by the sign of the notional and DV01 change and a participant can see the DV01 impact of the order prior to being submitted.

Participants also may designate the following parameters either for each order or as default across all orders: DV01 tolerance (the net change in DV01 below which they will be required to trade; or Date tolerance (the difference in the ending tenor that they will accept). For DV01 tolerance, participants may define a minimum (there is no maximum which implicates the process). For example, a participant enters a switch as a +$50,000 DV01 impact on the long-dated leg and a DV01 tolerance of $5,000. The participant is committing to trade against a switch where opposite side of the long-dated leg is between −$55,000 and −$45,000. For date tolerance, valid values may include same week, same ½ month, same month, and/or same quarter.

The platform may support an API that automates submission of positions from participants or that can automatically pull in trades from various sources (e.g., a position book).

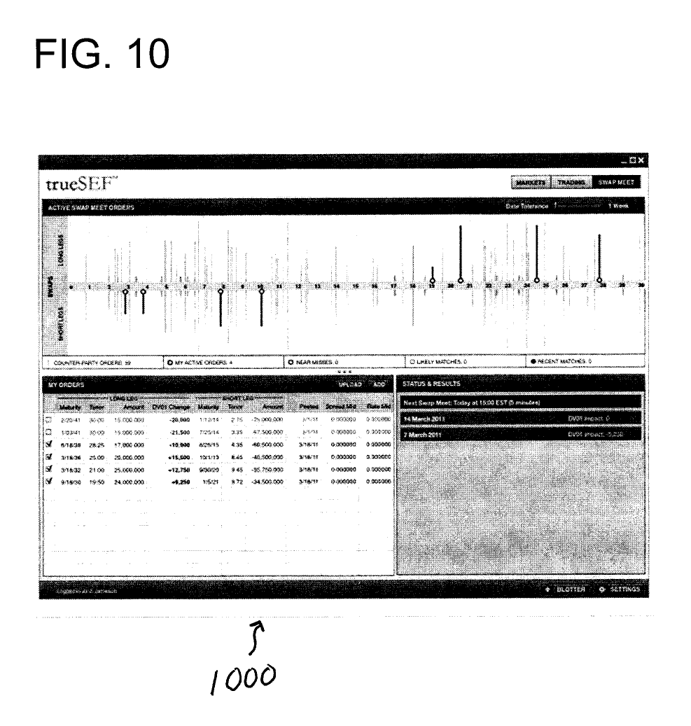

Following the submission of their orders (but prior to the processing), participants may view all of their net positions relative to the overall market. FIG. 10 shows a display 1000 embodying an example of a participant submitted position relative to all other submitted positions in a RAS run.

Trade Matching, First Run.

The trade matching, first run, may be executed after the Futures market closes—e.g., 4:15 PM. This would allow the platform to snapshot the latest curve and reflect that in participants' RAS orders.

Fifteen minutes before the process begins, the RAS platform may snapshot the Interest Rate curve (capture and baseline the latest prices) and update the orders to reflect the baselined prices. Participants may then have a designated amount of time (assumed 15 minutes) to adjust their orders—including activate and inactivate as necessary.

At the designated time, the RAS platform may begin processing the orders. The system can indentify counterparties who have the desire to adjust their exposure in opposite directions and either create specific trades or identify near-misses, specifically orders that could possibly match if the participant expanded their DV01 or date tolerance. The RAS platform may use the live (or the most recent relevant) prices from interest rate swap platform to determine DV01 impacts.

For switches, the platform may determine the best match (lowest DV01 impact) and include it in the trade set. For individual leg orders (in a subsequent phase), the platform may find two individual orders that have contra DV01 impacts and create them as a single trade (i.e., create a switch from individual orders).

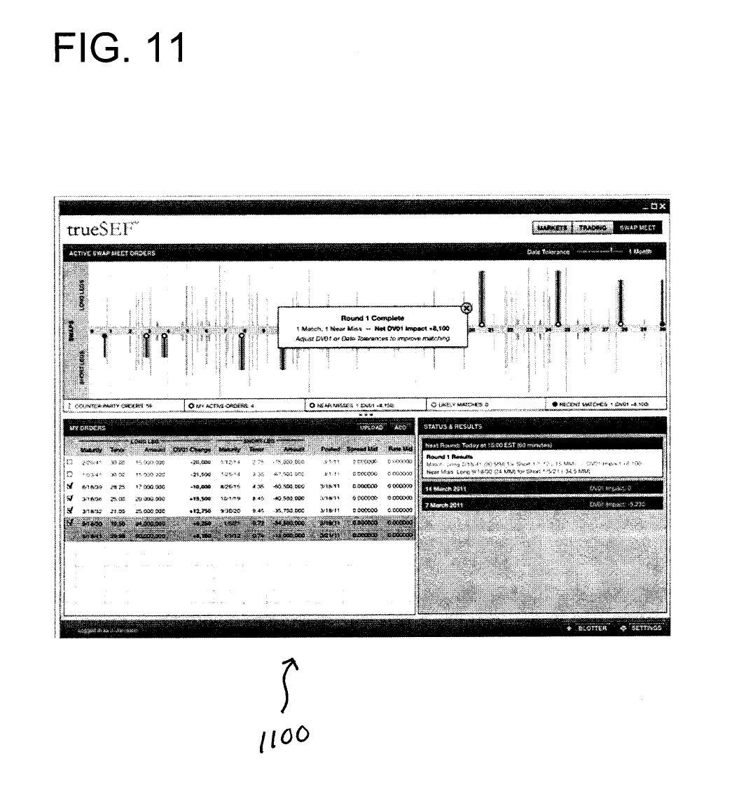

At the end of the first run, participants may be presented with the following information: trades that are matched (meaning they are below the DV01 tolerance with both counterparties and a trade has been executed); and orders that are near misses (meaning they are outside the DV01 tolerance for this participant—and may also be outside for the other participant). An example display 1100 of a possible presentation of this information is shown in FIG. 11.

At the end of the first run, participants may be shown: the notional matched and remaining notional for their original entry; the overall DV01 impact for all executed trades; the tenor level of match (+/− number of days from their order); and for cleared trades, the margin delta for each trade plus the overall margin impact (across all agreed sets).

Trade Matching, Second Run.

As with the First Run, the RAS Second Run may be executed after the Futures market closes—e.g., 4:15 PM—and based on the baselined prices (as described above).

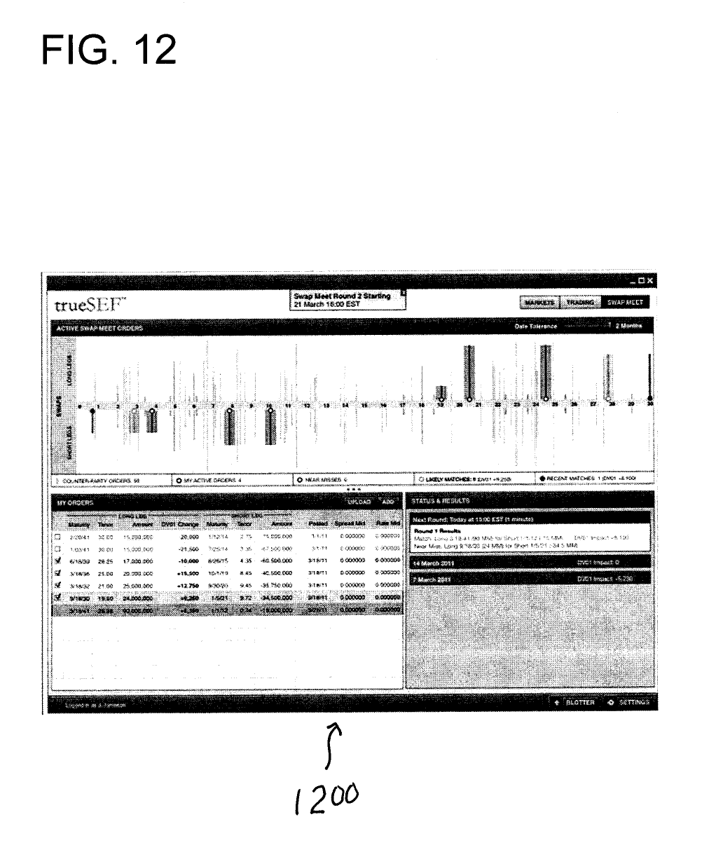

Before the second run, participants may be given the opportunity to increase the number of trades they want to execute. For orders that are near misses, participants may be allowed to adjust their date tolerance or DV01 tolerance. By adjusting the date tolerance, the participant may be able to potentially match other orders. As the participant increases his date tolerance, the platform may show likely matches during the second run. Similarly, adjusting DV01 tolerance may allow for additional matches from the near misses. FIG. 12 shows an example display 1200 of an interface for a participant to adjust his date tolerance to increase the chances of matches.

At a designated time, the platform may start the second run. The process may be the same as the first run—except that near-misses may not be identified. Each participant may be informed of the orders that are matched (meaning they are below the DV01 and date tolerance with both counterparties and a trade has been executed).

At the end of the second run, participants may be shown the same information as was shown at the end of the first run for trades: the notional matched and remaining notional for their original entry; the overall DV01 impact for all executed trades; the tenor level of match (+/− number of days from their order); and for cleared trades, the margin delta for each trade plus the overall margin impact (across all agreed sets). Trades may not be identified to users as first run or second run; instead they may be shown as a single set of trades.

Order Parameters.

There are two order parameters that the platform may use to facilitate matches—DV01 tolerance and Date (Calendar) tolerance.

Date tolerance is needed because there are no standard trade date conventions in the Interest Rate Swap market (effective date can be any date) and because the RAS process focuses on illiquid parts of the curve. Therefore exact date matches are not likely (and not essential).

When a participant enters an order, the platform may determine DV01 impact of each leg (by using the current live rates curve on the interest rate swap platform) or the participant may enter the DV01 impact directly. DV01 tolerance is needed because: notional values on the switches are not likely to match. In effect, the tolerance defined by the participant tells the platform the level how close to his original notional the trade must be to execute; and specific order dates are not likely to match. Therefore, the mismatches in dates may result in a (likely small) mismatch in DV01 impact.

Matching Approach.

In the initial phase, the RAS platform may create trades by locating as close a match to an order that has the opposite terms in the order. In the simplest form, orders would match exactly and create a trade with two parties. However, to maximize the number of trades performed, the RAS platform may need to match across multiple orders to create a linked chain of orders. For example, consider the following orders (assume all are for $50,000 DV01 change): participant A submits an order to sell 4.5 year and buy 12.5 year; participant B submits an order to buy 4.5 year and sell 8.5 year; and participant C submits an order to buy 8.5 year and sell 12.5 year.

In a simple matching, these orders would not trade because they didn't match. On the other hand, if the platform supported chaining of the orders, all of the orders could trade and maximize the value of the process to the participants. In this case, Participant A will sell to B and buy from C, Participant B will buy from A and sell to C, and Participant C will sell to A and buy from B.

To support maximization, the RAS platform may employ a linear programming technique to maximize the notional traded across the platform. Specifically, the platform may perform the following processing to match orders: break switches into individual legs to create individual orders (in the future phases, when orders can be individual legs, those orders will be used as entered); using tolerance settings, identify orders that have a contra position; for those orders without a contra position, eliminate them (and their corresponding order if in a switch) as they could not match; and for the remaining orders, try to create networked chains of orders that optimizes the overall set of matches for all counterparties.

The optimization may be achieved by setting up an optimization procedure wherein the variables are the DV01 impact amounts of the orders and the objective of the optimization is to maximize the total notional amount traded across all counterparties. Constraints may be added to the optimization algorithm to ensure that each participant's cumulative and specific order DV01 can change within a specified range of values. By allowing DV01 positions for any specific order to change to be closer to the desired DV01 impact of the order and by constraining the total DV01 to move in a small range of values, the optimization procedure ensures (to some extent) DV01 (and hence, PV) neutrality of the resulting set of trades.

Post Trade Processing.

Following the RAS run, if any trades are executed, the overall interest rate swap platform may process the trades in the same manner as regular trades executed via the normal order book. This may include sending trade information to market services (e.g., MarkItSERV), clearing houses, and the counterparties involved.

Participants may also view their unmatched orders. Participants involved in the curve management process may also view the aggregate positions of unmatched orders across all participants.

RAS Specific Displays.

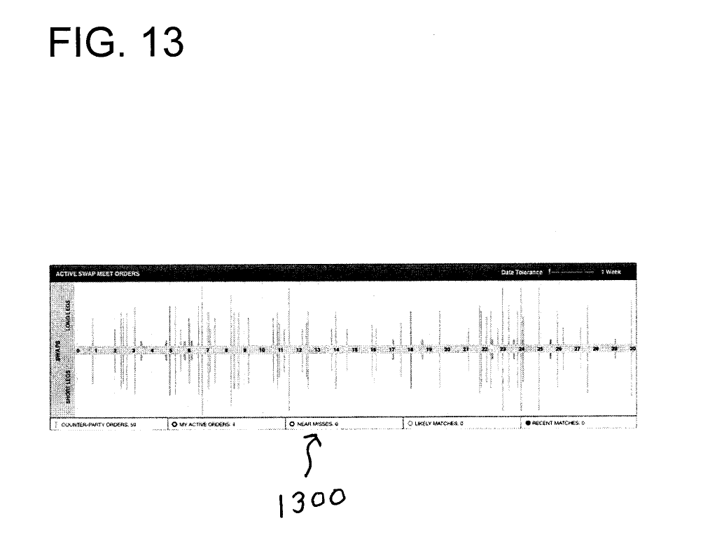

A RAS user interface 1300, as shown in FIG. 13, may present a graphical display of potential non-standard tenor switches in a Swap Execution Facility (SEF)—including showing market activity prior to the execution of the RAS process.

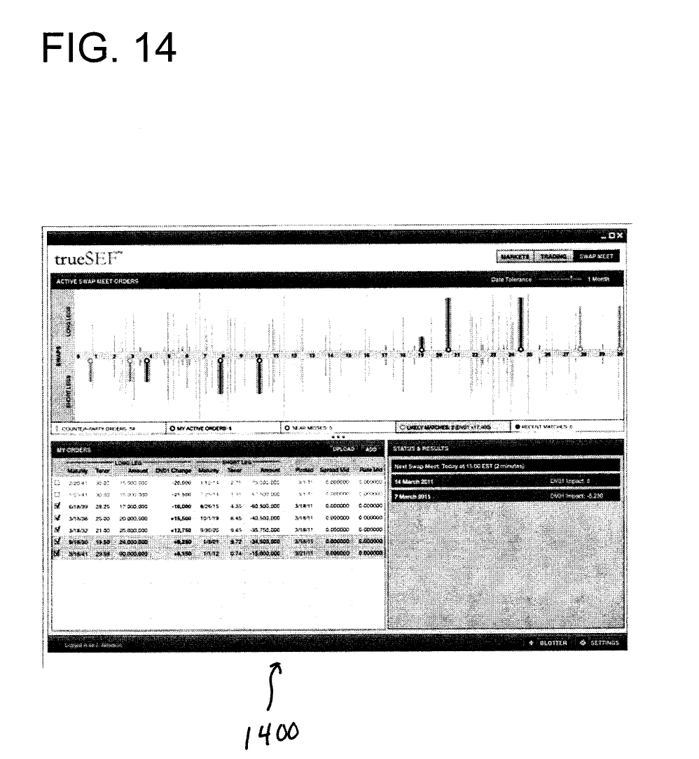

The RAS user interface may additionally display 1400 predictive and actual matching of non-standard tenor switches in an overall interest rate swap platform, as driven and updated by adjustment to user tolerances to show coverage of the user's order across multiple date ranges, as shown in FIG. 14.

Consolidated Sweep of the Books.

Interest rate swap market participants spend much of their time focused more on risk management than outright trading. In many cases, major swap dealers (MSDs) may be asked to quote a swap participant for large notional trades. The MSD will quote according to where they feel the market is at that time and where they can get a best executable hedge done against that quote. In order to do so, it is beneficial to the MSD to be able not only to view the stack of prices to gauge the depth of the market but also to ascertain where they can hedge a large size immediately. The consolidated sweep of the book function may be designed to facilitate such trades.

The standard methodology to trade larger sizes would be to sweep the book. Sweeping the book involves lifting every offer, or hitting every bid up to the highest, or lowest price, which provides an average price for the user. Once all those trades have been filled, any benefit of iceberg orders will be passed on to the user though a better average price fill. The market will know a large trade has been executed, as the top of the book will change by maybe two or three price levels.

The overall interest rate swap platform may view a consolidated sweep order as one that lifts through the stack of prices creating an average price as each price level trades. The consolidated sweep may be executed as a single order, despite matching on many individual orders in the order book.

On the overall interest rate swap platform, each tenor for an interest rate product may have a stack of orders comprising price levels and notional sizes. These may or may not include iceberg orders—i.e., orders with a hidden notional in addition to the visible notional. For a specific product and tenor, the interest rate swap platform may provide a view of current set of notional amounts as well as allow a user to manually enter a notional amount and responds with an average price to do a consolidated sweep of the order book.

FIG. 2 illustrates an example display 200 of the consolidated sweep concept for a 5-year tenor in a semi-bond product. The stack of orders shows the top of the order book comprising an offer in $30 MM at 2.31100 and a bid for $60 MM at 2.30410. Default consolidated sweep options are shown to the left of the price stack creating average all-in prices for those notional sizes. For example, to lift an offer of $120 MM, the all-in price will be 2.31109% and for $180 MM, it would be 2.31111%. The interest rate swap platform also allows the user to enter any notional amount they choose. These notional amounts may be provided as “custom” amounts. In the example, the notional amount of $150 MM creates an average price of 2.30402% and 2.31110% for the bid and offer respectively.

Enter Consolidated Sweep Order.

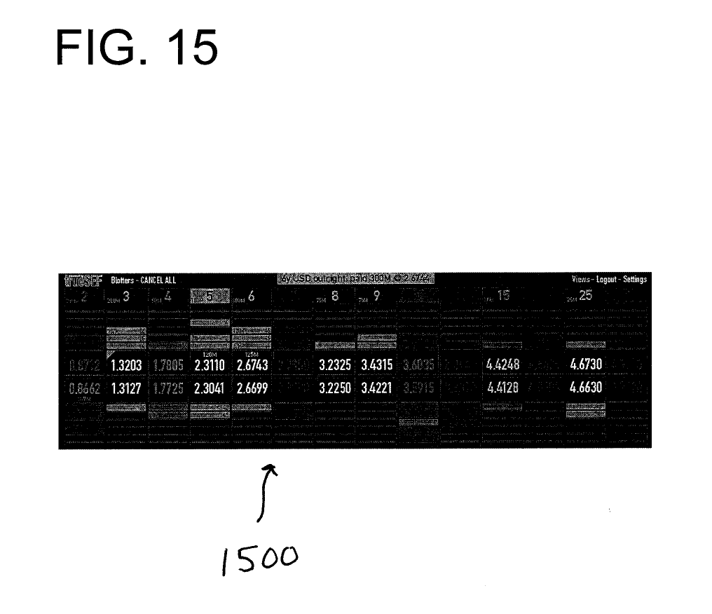

A participant may elect to enter a consolidated sweep order either by selecting a pre-determined amount or by entering a specific amount as desired. The interest rate swap platform may require confirmation of the order request and then process the consolidated sweep order as a single order in the platform. FIG. 15 shows a confirmation display 1500 for a consolidated sweep order, including price and notional amount being traded.

If an iceberg order is part of the stack, the consolidated sweep process may give the user a better average price upon execution as the weighted average price may be changed to incorporate the hidden size of the iceberg order. As a result, the consolidated sweep order could be considered a limit order at the selected average price.

Execute Consolidated Sweep Order.

The overall interest rate swap platform may display orders that are live at the time of the request. In each case, the actual execution price may be determined by the contra orders available at the time that the consolidated sweep order reaches the server. If the order book on the contra side no longer has sufficient liquidity to fulfill the consolidated sweep order, the consolidated sweep order may be canceled. The interest rate swap platform may allow for a partial fill of the consolidated sweep order, whereby the full notional amount of the order may not be filled, but the price level for the amount filled is greater than the requested limit order price. Any unfilled portion of the consolidated sweep order will either become the new top of the order book at that consolidated sweep order price or cancelled at the initiators option.

Upon execution, the overall interest rate swap platform may provide an execution report to the participant that submitted the consolidated sweep order. The contra orders may be notified as well, but would only see their specific execution (not the entire consolidated order execution details.)

Post-Trade Processing.

Following the execution of the consolidated sweep order, the interest rate swap platform may process each individual order in the same manner as regular trades executed via the normal order book. This includes sending trades to market services (eg. MarkitSERV), clearing houses, and the counterparties involved including an outright confirmation of the actual VWAP trade to the initiator.

Credit Verification.

The introduction of swaps trading on swap execution facilities (SEFs) and designated contract markets (DCMs) (collectively “Electronic Trading Platforms”) and the clearing of swaps at clearinghouses, may provide the ability for counterparties to have certainty that a matched order will result in a valid, cleared trade. The structure of clearinghouses, and clearing firms that are authorized to clear trades at a clearinghouse, requires that an electronic market—either a DCM or SEF—must be able to verify that credit restrictions defined by the clearing firms with respect to parties on the Electronic Trading Platforms are not breached for matched orders. The credit limit concept implemented on the interest rate swap platform (IRSP) provides this assurance for trading and clearing on an electronic platforms.

Clearing Routes.

An essential part of managing credit limits is defining clearing routes. A clearing route may be defined as the combination of clearing firm (also called clearing member) and clearinghouse for an entity that wishes to have their trades cleared. The entity may be an executing broker (also called executing participant) or a customer of an executing broker—through which the customer gains access to an Electronic Trading Platform. (NOTE: The different types of entities are not distinguished in the following text because credit limits apply to any firm wishing to trade on the IRSP.)

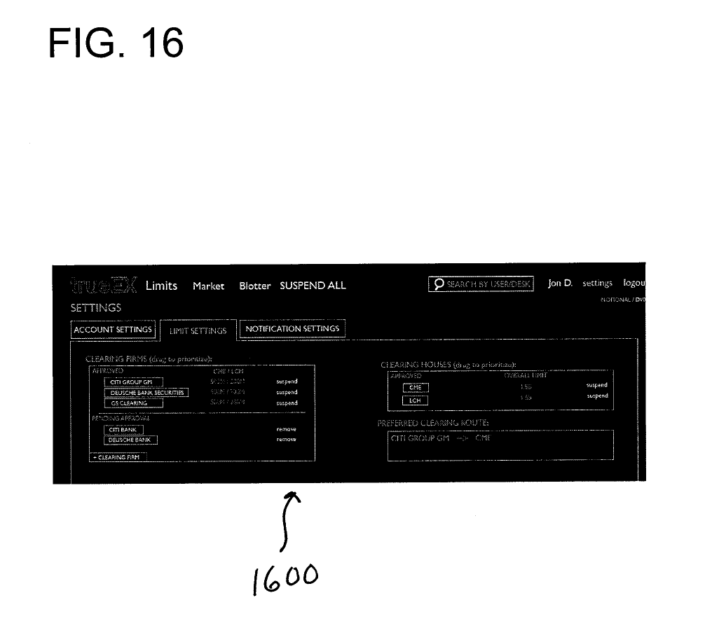

Entities may be required to define their clearing route to ensure that any trade they enter is properly routed to a clearinghouse via the approved clearing firm. In many cases, entities will have several clearing firms and several clearinghouses that they use. In such cases, the entity is able to set up several clearing routes—and also define their preferred order of usage of these clearing routes. Customers are also able to define their preferred executing participants as part of their clearing routes, such as through an interface 1600 as shown in FIG. 16.

When an action is taken on the trading platform, the platform may use the definition of preferred trading routes to attach the route to the order or trade being created. Users may always override the preferred order if desired.

Defining Credit Limits.

Clearinghouses set credit limits for the firms that are authorized to clear at their facilities. These are enforced and managed by the clearinghouse. For a trading platform, clearing firms need to be able to define what portion of those limits are allocated to their own institution's executing participants, to external executing participants and to their customers.

The present system and methods may define a facility for clearing firms to establish credit limits for their approved clearing entities. These limits are set at the firm level and defined in terms that are relevant for the swap. For example, on interest rate swaps, the limits may be expressed in terms of DV01 (the dollar value of a one basis point decrease in interest rates). DV01 is used to duration weight (normalize) the notional amount traded. E.g., the exposure of a 30-year swap is significantly higher than a 5-year swap due to its longer duration. On credit defaults swaps since most of the trades are in standard tenors, simple notional limits may suffice. In both cases, a maximum duration setting is available to the clearing firm. While these are the limit calculations we have defined in this embodiment, any value that can be effectively calculated (e.g., initial margin at a clearinghouse) could be used to set credit limits. For the purposes of this document, we assume that a credit limit is a simple numeric calculation applied to an order being auctioned on the interest rate swap platform.

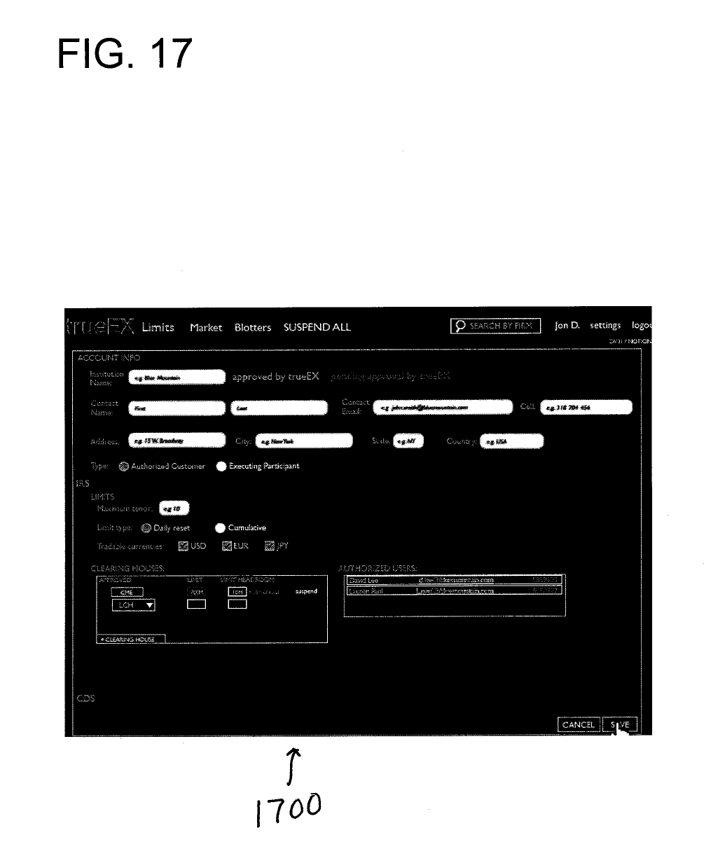

Clearing firms may use the interest rate swap platform to define their desired limits for a particular entity at a specific clearinghouse. If the clearing firm supports more than one clearinghouse, they may (but do not have to do so) provide credit limits to their entities at more than one clearinghouse. FIG. 17 illustrates a user interface 1700 for allocating limits. The credit limits may either be temporary, lasting only for the current trading day, or permanent, i.e., a daily limit that is reset each day, until changed or revoked by the clearing firm.

Temporary limits are reset (to zero) at the end of a trading day. If the clearing firm wishes to allow an entity to clear on the next trading day, they may have to enter an updated limit for the entity. Permanent limits may be reset each day to their original levels by the platform but a clearing firm may adjust those limits whenever they choose.

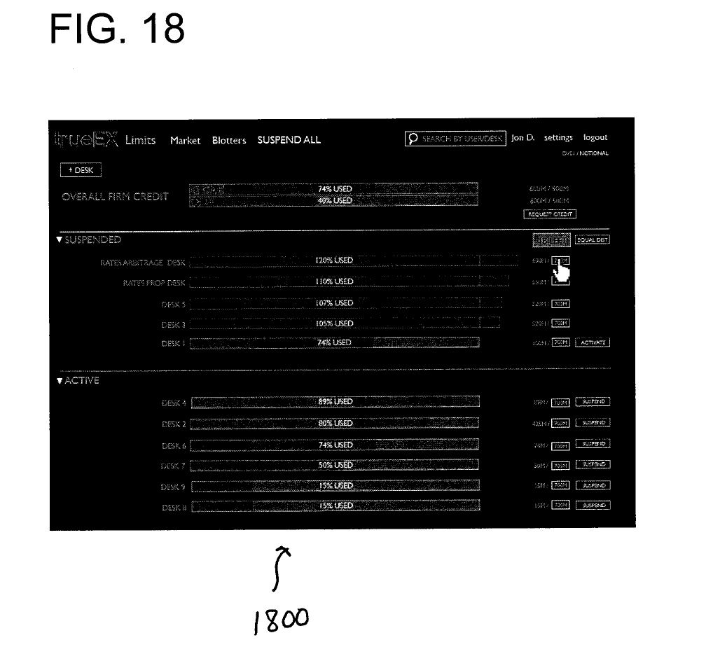

Once the clearing firm sets the credit limits, the entity can further allocate those limits within their own organization. In one embodiment, the concept of a desk (group of traders with a specific objective) and traders may be supported. Each entity should have at least one desk and one trader. The entity can allocate the limits provided by them to their desks and to traders on the desks as they desire. If no allocation is done, the platform may allocate the limits proportionally. In addition, these limits may be re-allocated as the credit is used or updated (e.g., additional credit is added by the clearing firm). FIG. 18 illustrates a user interface 1800 for re-allocating limits.

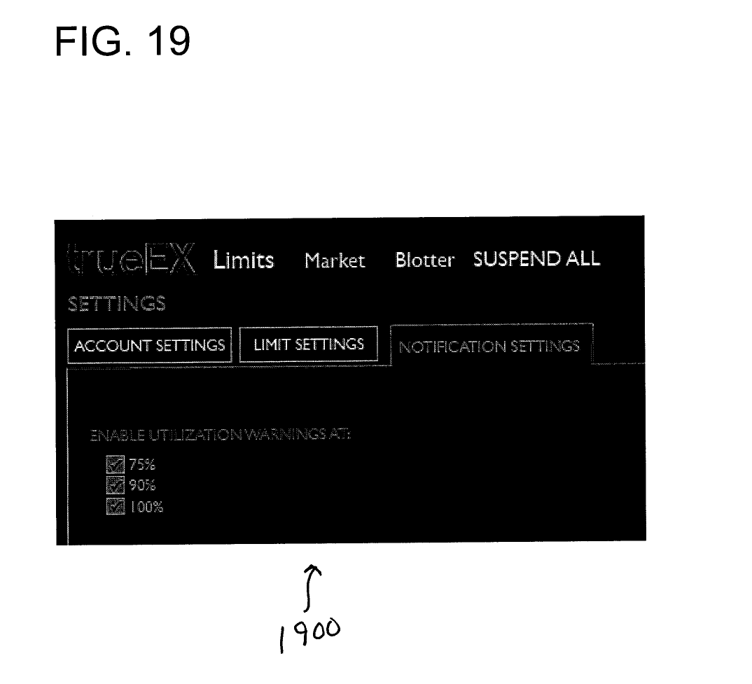

When setting credit limits for an entity, a clearing firm may have the ability to set notification triggers and breach limits to better manage the credit limits they have established for their entities. The notification limits trigger automated notifications to the designated person at the clearing firm that the entity is nearing a limit (be it permanent or temporary). For example, if the trigger is set to 75%, the platform will generate a notification if the entity uses more than 75% of their approved limit. The clearing firm can use these notifications to be informed as the entity approaches their credit limit. In addition, the clearing firm can define a maximum level (as a percentage of the credit limit). This maximum will provide a hard cap on the credit limit. When an entity reaches the maximum, they will not be allowed to commit their entity to any further actions until they are provided with additional credit by the clearing firm. FIG. 19 illustrates a user interface 1900 for managing credit line warnings as a percentage of existing credit limits.

Committing to Use Credit.

The key to effective enforcement of credit limits is the management of how and when that credit is used by entities. Conceptually, the credit limit is impacted when an entity does a trade. However, this ignores situations where the entity has live orders on the platform that may be traded at any time. Specifically, a trading platform may clearly define the rules over how credit is utilized by a specific action.

Instead of adjusting credit limits after a trade in one embodiment, the IRSP platform may adjust credit before a user takes any action where the user is reasonably likely to do a trade. This may be done to provide the certainty of trading for all parties since any live order could then be guaranteed to have sufficient credit to clear.

On the interest rate swap platform, multiple order types may be supported. Each type commits (or releases) the use of a portion of a credit limit when the order becomes active (or is canceled). The order types may include central limit order book (CLOB) orders, request for quote (RFQ) orders, block trade affirmation orders, and off-the-run affirmation orders.

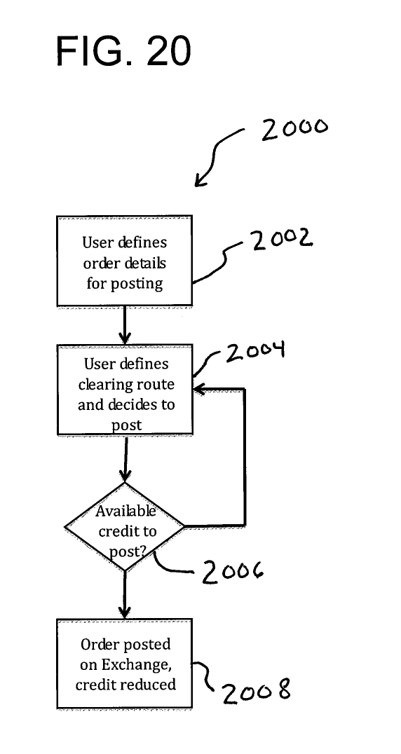

As shown in FIG. 20, the following process may occur when posting a CLOB order: a user may identify 2002 its order details (price, notional, time valid, etc); the user may also identify 2004 its clearing details—including clearing firm and clearinghouse (which information may be defaulted to a user's preferred route); the user can request that the platform post the order to the market; the interest rate swap platform may then perform 2006 a credit limit check by evaluating the order details against the user's credit limit; if the check fails, the interest rate swap platform may reject the order. The user may try to post the order to the platform by starting over if they have more than one clearing route (at step #2); or if all of the limit checks pass, the order may be posted 2008 and the credit limit reduced by the amount of the order.

If the order is ever matched and a trade created, the credit limit may not need to be rechecked because it would already have been accounted for in the processing when the order was posted.

Similar work flows may occur when a user initiates an RFQ order. The RFQ order is considered a commitment to trade—and credit limits are evaluated and processed accordingly. The process may include the steps of a user identifying RFQ details (price, notional, time valid, etc) and participants to receive the request; the user may also identify clearing details, including clearing firm and clearinghouse (this may be defaulted to a user's preferred route); the user may request the interest rate swap platform to post the RFQ to the identified participants; the interest rate swap platform may perform a credit limit check against the user's credit limit; if the check fails, the interest rate swap platform may reject the RFQ, in which case the user may try to post the RFQ to the platform by starting over if they have more than one clearing route (at step #2); if all of the limit checks pass, the RFQ is distributed and the credit limit is reduced by the amount of the RFQ; if the creator of the RFQ accepts any response and a trade created, the credit limit does not need to be rechecked because it has already been accounted for in the processing when the RFQ was posted.

The interest rate swap platform may also support an affirmation model for certain types of orders—such as block trades and off-the-run trades. For affirmation orders, the following work flow may be implemented: a user may identify affirmation order details (price, notional, time valid, etc) and their counterparty in the trade; the user may also identify clearing details for their order, including clearing firm and clearinghouse (which can be defaulted to a user's preferred route); the interest rate swap platform may also identify the clearing route for the counterparty (via the counterparty's preferred route); the user may request that the platform post the affirmation orders (both buyer and seller) to the platform; the interest rate swap platform may then perform a credit limit check for each order against the respective user's credit limit; if any of the checks fail, the IRSP platform rejects the affirmation orders. The user may try to post the affirmation orders to the platform by starting over if they have more than one clearing route (at step #2); if all of the limit checks pass, the affirmation orders are distributed and the credit limit for both counterparties is reduced by the amount of the order; if the counterparty of the affirmation order affirms the order and a trade is created, the credit limit does not need to be rechecked because it has already been accounted for in the processing when the affirmation orders were posted.

Traders may also use a portion of their credit by “aggressing” an existing live order to create a trade. In this scenario, the trader creates a contra order to the existing live order (as an immediate or cancel—“IOC”—order) that will either trade or be canceled. The following work flow may occur when aggressing a CLOB order: a user may identify the order it wishes to aggress, including the order details (price, notional, etc); the user may also identify clearing details, including clearing firm and clearinghouse for their order (the live order will already have it defined); the user may request that the interest rate swap platform to aggress the live order; the interest rate swap platform may perform a credit limit check based on the order details against the user's credit limit; if the check fails, the platform may reject the aggressing user's contra order. The user may try to aggress the live order to the platform by starting over if they have more than one clearing route (at step #2); if the credit limit check passes, the contra order may be entered and either matched (with the credit limit reduced by the amount of the contra order) or cancelled because the original order price is no longer available (and the credit limit resets to the original levels.)

Users can release previously committed credit to enable them to take other actions on the platform. This is usually done by cancelling a previously placed order or similar action. The cancel could be system-driven (e.g., an RFQ expires) or user-driven (user cancels all orders or a specific order). Regardless of how it is initiated, the work flow may include the steps of: a user requesting the interest rate swap platform to cancel an order, RFQ, or affirmation order; the portion of the order that has not yet traded (i.e., in a situation where the order is already partially filled) is canceled and the credit limit is increased by the amount of the cancelled order (or portion thereof).

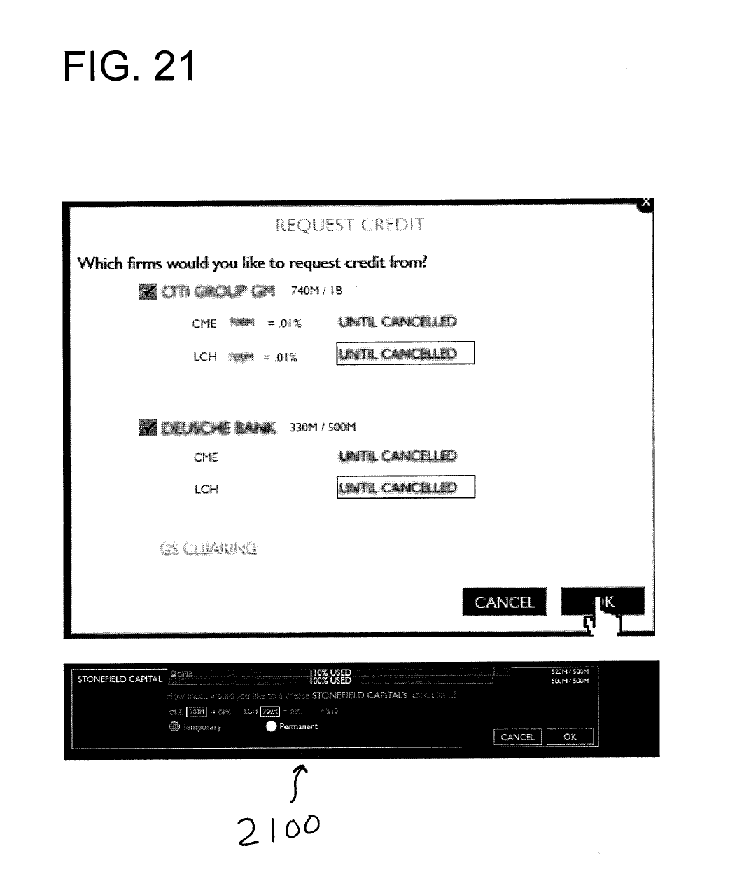

The interest rate swap platform may have a facility, as shown in the user interface 2100 in FIG. 21, that allows for users to request more credit. This allows for users to inform a clearing firm that they wish to get additional credit so that their credit limit accommodates their trading plans.

Order Matching.

Because every order, regardless of type, is electronically tagged by the IRSP platform with a clearing route—that includes the clearinghouse where the trade would clear—the IRSP platform may only match those orders that would be routed to the same clearinghouse. If the trading route needed to be changed on an order, the user could cancel the original order and place a new order on the platform. At that point, the credit limit process for cancelling and placing an order (as described above) would be relevant.

Breaching Limits.

When entities reach their credit limit, the IRSP platform may enforce the credit limit to ensure the entity did not exceed the specific limits set by the clearing firm. The clearing firm would be able to define the level of breach allowed (e.g., 100% means it will breach at the defined level, 125% means the entity can trade up to 125% of the limit before there will be a breach). Once the limit is breached, the IRSP platform could prevent the entity from taking any action that reduced their available credit.

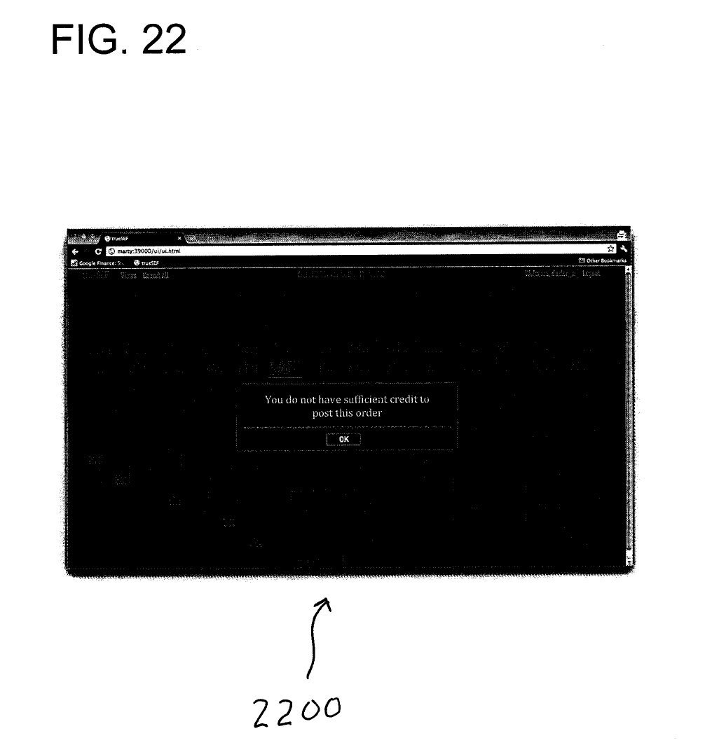

When an entity breaches the limit, the entity may be informed, as illustrated in the display 2200 shown in FIG. 22, of the breach and the action taken may be canceled. The exception is when an entity is aggressing an order. In this case, the entity is allowed to do a partial fill (up to the maximum credit allowed) of the order.

The entity can take measures to allow them to perform actions on the platform again. The entity can request additional credit from the clearing firm. They can cancel existing live orders (which as described above, will release credit to the entity). They can also use credit made available from a different clearinghouse.

Monitoring Credit Usage.

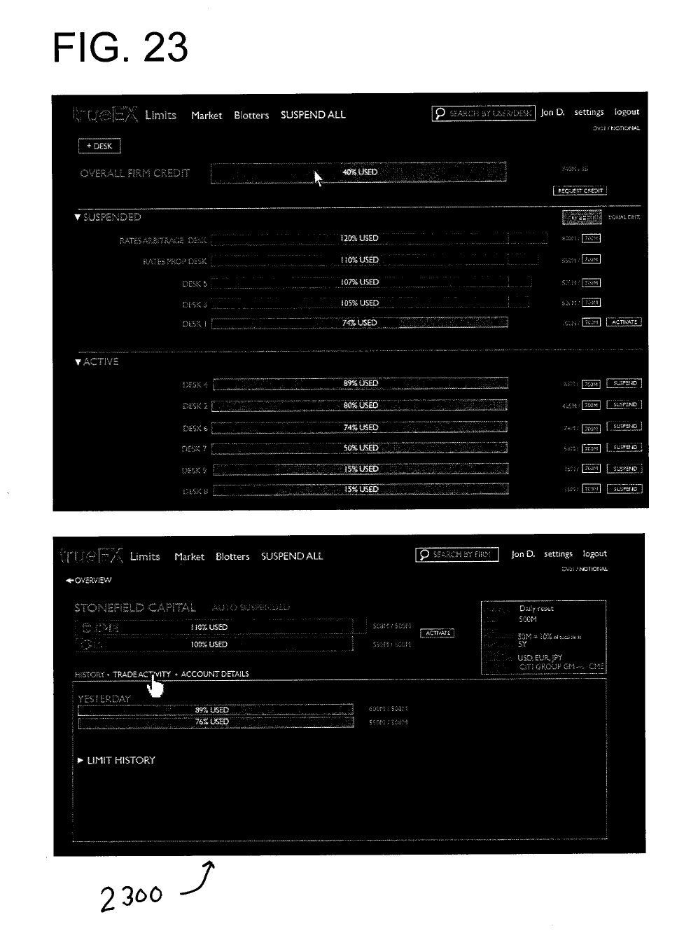

To provide effective management of credit limits, a clearing firm needs to have the ability to monitor the usage of the credit they have given to entities. The interest rate swap platform provides the ability to review—in real time—the status of credit limits for any entity that they have permission to clear trades, such as through the interface 2300 shown in FIG. 23. The clearing firm can review credit usage across all clearinghouses and also see detail for each clearinghouse. In addition to viewing the credit current status, the clearing firm can also review an entity's history of credit usage.

Kill Switch.

During times of market or company disruption, it is important for a clearing firm to be able to quickly suspend the use of credit across different entities, across different clearinghouses, or for all entities. To support this concept, the interest rate swap platform may implement the concept of a “Kill Switch”. The kill switch enables a clearing firm to immediately cause all credit limits to be suspended. When activating a kill switch, the clearing firm must identify for whom the kill switch applies (e.g., a specific entity, all entities, a clearinghouse, all clearinghouses).

If applied to an entity (either individually or for all entities), the following may apply: all CLOB orders and RFQs orders are canceled immediately; any Block or Off-the-Run affirmations are rejected immediately; further posting of any order type is not permitted; and orders matched, but not yet cleared, continue to be processed as normal (there is no attempt to remove a trade from a clearinghouse).

If applied to a clearinghouse (either individually or for all clearinghouses), the following may apply: all CLOB orders and RFQs orders that have the clearinghouse in the trading route are canceled immediately; any block or off-the-run affirmations routed to the clearinghouse are rejected immediately; further posting of any order type for that clearinghouse is not permitted; and orders matched, but not yet cleared, continue to be processed as normal (there is no attempt to remove a trade from a clearinghouse).

Invoking a kill switch does not change the specific details of the credit limits and amount of credit used. This process suspends the limits for all affected entities and clearinghouses. When the clearing firm chooses to re-enable the entities and clearinghouses, the credit limits may be restored to the levels in existence at the time when the Kill Switch was invoked

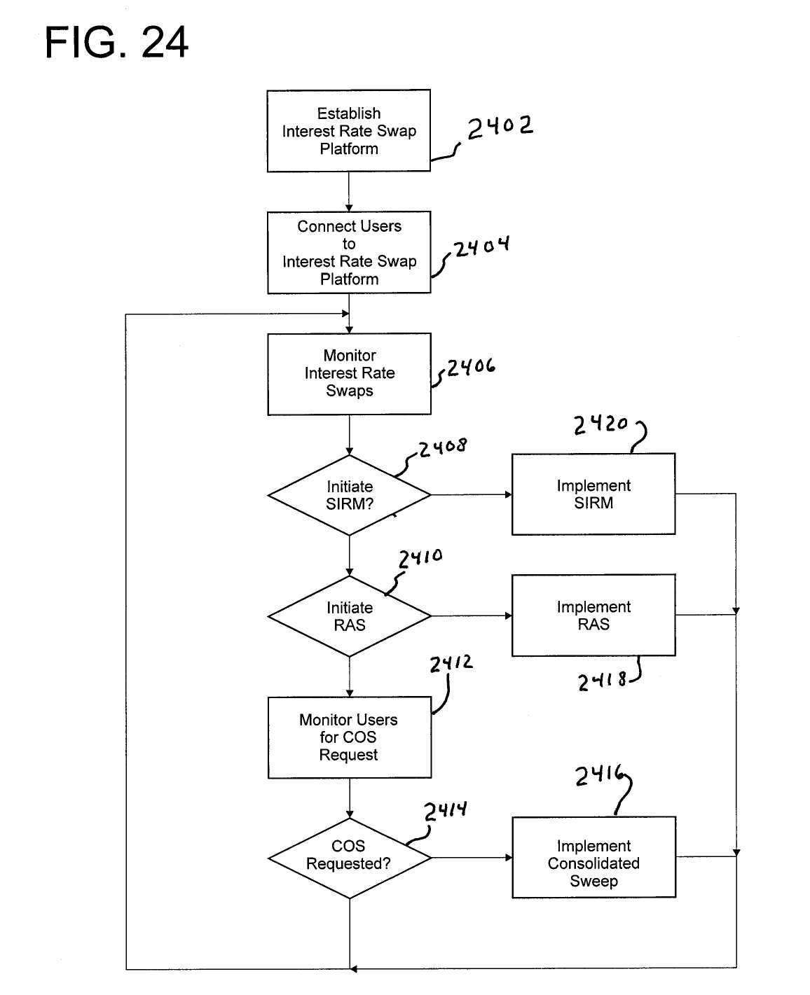

As is evident from the above, the complexities which may be implemented in the present system and method may be extensive, however the basic process remains the same, as is shown in FIG. 24. An interest rate swap platform (IRSP) is established 2402, and interested users are communicably connected 2404 to the IRSP. The IRSP may then monitor 2406 interest rate swaps (whether completed, offered, or requested), both providing general information to users regarding interest rate swaps identified during monitoring, analyzing the interest rate swap information to evaluate 2408 whether a SRIM should be instituted, and to determine 2410 whether a RAS session is indicated. The IRSP may additionally monitor 2412 user requests, or solicit user requests, regarding user requirements to implement a consolidated sweep of the user's book (CSB), which if requested 14, may be implemented 16. Each of the SRIM, IRSP, and CSB processes may be implemented 2420, 2418, 2416 as discussed above, including integrating credit limit parameters from a third party.

The present invention may be embodied in other specific forms without departing from the spirit or essential attributes of the invention. Accordingly, reference should be made to the appended claims, rather than the foregoing specification, as indicating the scope of the invention.

What is claimed is:

1) A computer-implemented interest rate swap platform comprising a computer system that includes: a plurality of user interfaces that elicit and receive information into the computer system from one or more participants in an interest rate swap market including single interest rate market sessions and risk adjustment sales; a market evaluator to monitor interest rates for presentation of the interest rates to users; a single interest rate market module, said single interest rate module configured to match buy and sell offers; a risk adjustment sale module; a consolidated sweep module; a client credit restriction module; and a transaction clearing module, wherein the plurality of user interfaces may be utilized by users with different roles in the interest rate swap market.

2) A computer-implemented interest rate swap platform in accordance with claim 1, wherein said single interest rate market module further comprises a user-initiated session function.

3) A computer implemented interest rate swap platform in accordance with claim 2, wherein said client credit restriction module is integrated with said single interest rate market module to impose credit restrictions identified by a credit facility to transactions proposed by a user.

4) A computer-implemented interest rate swap platform in accordance with claim 3, wherein said client credit restriction module further comprises an interface for a credit facility to immediately suspend credit support for participants on the interest rate swap platform.

5) A computer implemented interest rate swap platform in accordance with claim 2, wherein said single interest rate market module implements an initial session and a continuing session, said initial session being time limited.

6) A computer-implemented interest rate swap platform in accordance with claim 1, wherein said single interest rate market module further comprises a market activity initiation function.

7) A computer implemented interest rate swap platform, wherein said transaction clearing module sorts completed orders to aggregate orders associated with a user to minimize reports associated with said orders.

8) A computer implemented interest rate swap process, comprising the steps of:
Establishing an interest rate swap platform;
Communicably connecting users to said interest rate swap platform;
Monitoring interest rate swap market conditions;
Providing to said users information regarding said market conditions through a user interface;
Analyzing said market conditions to determine whether a single interest rate market session should be initiated;
Monitoring said user interfaces to determine when a user requests a single interest rate market session;
When either market conditions indicate or when a user request a single interest rate market session, initiating a single interest rate market session;
Periodically initiating risk adjustment sessions;
Monitoring said user interfaces to determine when a user requests a consolidation sweep associated with a portfolio of interest rate swaps associated with a user;
When a user requests a consolidation sweep, implementing said consolidation sweep; and
Imposing on one or more proposed transactions made during a single interest rate market session, a risk adjustment sale, or a consolidation sweep, a credit limit, on the ability of users to proposed transactions dependent on a parameter identified by a credit facility.

9) The computer implemented interest rate swap process of claim 8, further comprising reporting transactions resultant from a single interest rate market session to a clearing house upon completion of a single interest rate market session.

10) The computer implemented interest rate swap process of claim 8, wherein said single interest rate market session comprises an initial session and a continuing session.

11) The computer implemented interest rate swap process of claim 8, wherein said initial session has a fixed duration.

12) The computer implemented interest rate swap process of claim 10, wherein said continuing session has a variable duration.

13) The computer implemented interest rate swap process of claim 13 wherein said variable duration comprises a fixed initial duration, which is extended when predetermined parameters are met during said continuing session.

14) The computer implemented interest rate swap process of claim 8, wherein said market conditions include an order book identifying outstanding offers for interest rate swaps proposed by a plurality of users.

15) The computer implemented interest rate swap process of claim 14, wherein said the step of initiating a single interest rate market session comprises pushing a display to users, said display informing said users of the single interest rate market session.

16) The computer implemented interest rate swap process of claim 16, wherein said display informing said users of the single interest rate market session further comprises information regarding open offers for interest rate swaps.

17) The computer implemented interest rate swap process of claim 8, wherein said single interest rate market session prioritizes at least a portion of the offers for sale and offers for purchase in accordance with the time entry of the respective offer for sale or offer for purchase.

18) The computer implemented interest rate swap process of claim 8, wherein when said single interest rate market session has been initiated as a result of a user request to initiate, said user who requested initiation retains the highest priority on a transaction side on which said initiation was requested.

19) The computer implemented interest rate swap process of claim 8, wherein said single interest rate market session precludes a user form participating as both a seller and a purchaser during a particular single interest rate market session.

20) The computer implemented interest rate swap process of claim 8, wherein said step of imposing a credit limit further comprises the step of receiving from a credit facility credit limits to be applied to a user, and monitoring proposed transactions of said user to ensure that said proposed transactions do not exceed said credit limit.
